(19) United States
(12) Patent Application Publication
(10) Pub. No.: US 2013/0015012 A1
(43) Pub. Date: Jan. 17, 2013

(54) CHASSIS FOR AN ELECTRIC VEHICLE

(71) Applicant: DONALD P.H. WU, Hsinchu County (TW)

(72) Inventor: DONALD P.H. WU, Hsinchu County (TW)

(73) Assignee: ENERGY CONTROL LIMITED, TORTOLA (VG)

(21) Appl. No.: 13/180,883

(22) Filed: Jul. 12, 2011

(51) Int. Cl. B62D 21/00

(52) U.S. Cl. 180/312

(57) ABSTRACT

A chassis for an electric vehicle comprises: a base frame, a front frame, a rear frame, two side frames, four suspension devices and four wheels. The front frame and the rear frame have the front arc-shaped tube and the arc-shaped rear tube fixed to the base frame, the arc-shaped tubes can not only reduce the number of tubes required but also increase the area of thrust force as compared to the straight tubes. Besides, the arc of the arc-shaped tubes avoids a connection point of an acute angle, thus preventing stress concentration while improving the structural strength of the chassis. Further, the arc-shaped front tube, the arc-shaped rear tube, the front connecting tube and the rear connecting tube are hollow, which contributes to light weight of the chassis.

### BACKGROUND OF THE INVENTION

1. Field of the Invention

The present invention relates to a chassis, and more particularly to a chassis for an electric vehicle.

2. Description of the Prior Art

Vehicle is an indispensible part of our lives, and every vehicle has a chassis on which the rest parts of the vehicle are mounted, in other words, the chassis has to bear the load of the vehicle. Therefore, the strength of a chassis has a great influence on the vehicle's safety.

As shown in FIG. 1, a conventional vehicle chassis X comprises a plurality of tubes X1 connected together, and the angles between connected tubes X1 are either right angles or acute angles. The strength of the chassis determines the safety of a vehicle, and the structural weak points lie at the connection point between the tubes X1. When the angles are all right and acute angles, stress concentration will occur, which will cause structural damage and safety problem when the chassis X is overloaded or subjected to an impact force.

The present invention has arisen to mitigate and/or obviate the afore-described disadvantages.

### SUMMARY OF THE INVENTION

The primary object of the present invention is to provide a chassis for an electric vehicle which is simplified in structure, improved in safety and structure strength, and has less structure weak points.

To achieve the above object, a chassis for an electric vehicle in accordance with the present invention comprises: a base frame, a front frame, a rear frame, two side frames, four suspension devices and four wheels.

The base frame is a rectangular structure formed by two side tubes, a front tube and a rear tube connected at both ends of the two side tubes.

The front frame includes two arc-shaped front tubes with one end fixed to both ends of the front tube of the base frame, and a front connecting tube connected between another ends of the two arc-shaped front tubes. The front frame is further provided with two front mounting platforms connected to the two arc-shaped front tubes, respectively.

The rear frame includes two arc-shaped rear tubes with one end fixed to both ends of the rear tube of the base frame, and a rear connecting tube connected between another ends of the two arc-shaped rear tubes.

Two of the four suspension devices each have one end fixed to the two front mounting platforms of the front frame and another end fixed to two of the four wheels, and another two of the four suspension devices A each have one end fixed to both ends of the rear connecting tube and having another end fixed to another two of the four wheels.

Since the front frame and the rear frame have the front arc-shaped tube and the arc-shaped rear tube fixed to the base frame, arc-shaped tubes can not only reduce the number of tubes required but also increase the area of thrust force as compared to the straight tubes. Besides, the arc of the arc-shaped tubes avoids a connection point of an acute angle, thus preventing stress concentration while improving the structural strength of the chassis. Further, the arc-shaped front tube, the arc-shaped rear tube, the front connecting tube and the rear connecting tube are hollow, which contributes to light weight of the chassis.

### BRIEF DESCRIPTION OF THE DRAWINGS

FIG. 1 is an illustrative view of a conventional chassis;

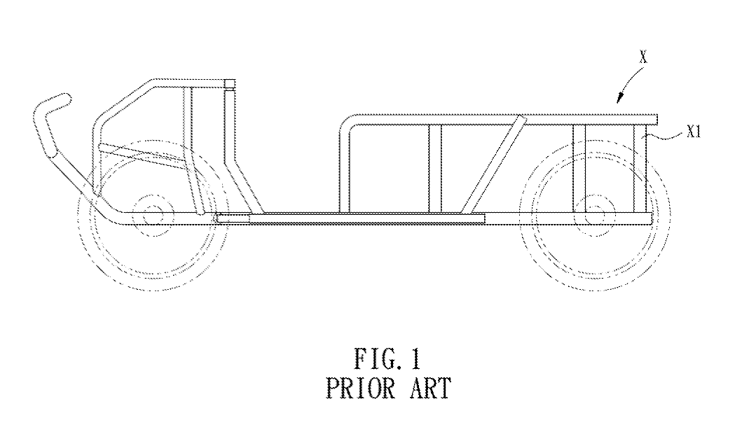

FIG. 2 is a perspective view of a chassis for an electric vehicle in accordance with the present invention;

FIG. 3 shows that on the chassis for an electric vehicle in accordance with the present invention are mounted wheels and suspensions;

FIG. 4 is a front view of a part of FIG. 3; and

FIG. 5 is an illustrative view showing a completed assembly of an electric vehicle.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

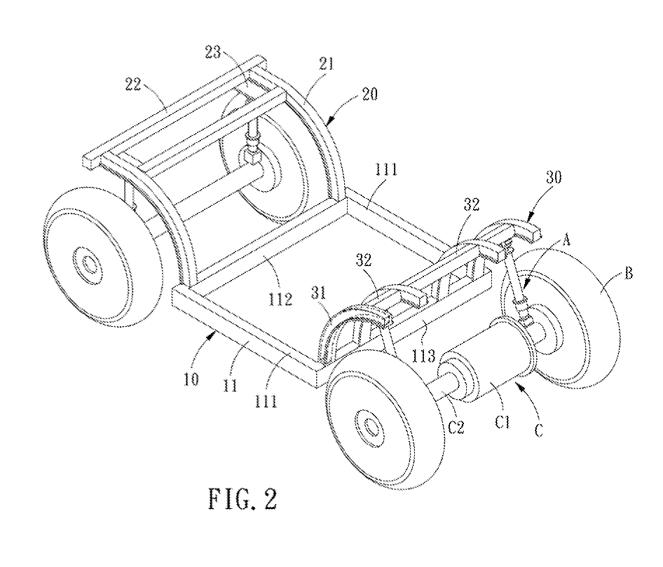

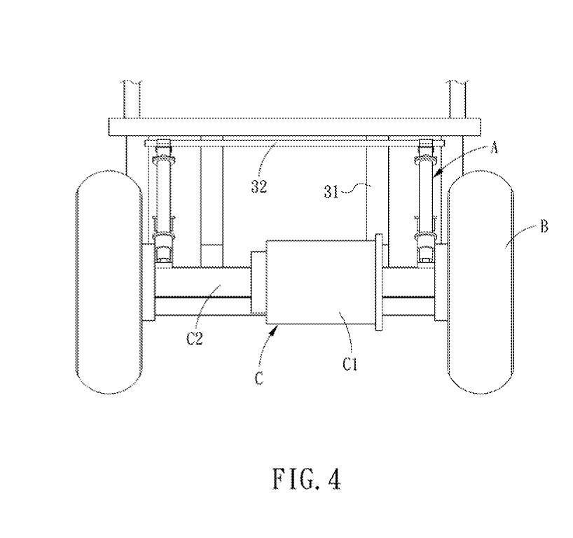

Referring to FIGS. 2-5, a chassis for an electric vehicle in accordance with the present invention comprises a base frame 10, a front frame 20, a rear frame 30 and two side frames 40.

The base frame 10 is a rectangular structure formed by two side tubes 111, a front tube 112 and a rear tube 113 connected at both ends of the two side tubes 111. The base frame 10 is further provided with a container 12 for storing battery, and a plurality of reinforced tubes 13 for improving the load capacity of the base frame 10.

The front frame 20 includes two arc-shaped front tubes 21 with one end fixed to both ends of the front tube 112 of the base frame 10 and a front connecting tube 22 connected between another ends of the two arc-shaped front tubes 21. The arc-shaped front tubes 21 and the front connecting tube 22 are square in cross section. The front frame 20 is further provided with two front mounting platforms 23 connected to the two arc-shaped front tubes 21, respectively.

The rear frame 30 includes two arc-shaped rear tubes 31 with one end fixed to both ends of the rear tube 113 of the base frame 10, and a rear connecting tube 32 connected between another ends of the two arc-shaped rear tubes 31. The arc-shaped rear tubes 31 and the rear connecting tube 32 are square in cross section.

Each of the side frames 40 is an arc-shaped tube with both ends fixed to the front frame 20 and the rear frame 30, respectively.

The chassis in accordance with the present invention is used for mounting of four suspension devices A and four wheels B in such a manner that two of the four suspension devices A each have one end fixed to the two front mounting platforms 23 of the front frame 20 and another end fixed to two of the four wheels B, and another two of the four suspension devices A each have one end fixed to both ends of the rear connecting tube 32 and have another end fixed to another two of the four wheels B. The load of the vehicle is pressed on the suspension devices A and finally on the wheels B through the front frame 20 and the rear frame 30. That is to say, the front frame 20 and the rear frame 30 bear the main load of the vehicle. Since the front frame 20 and the rear frame 30 have the arc-shaped front tube 21 and the arc-shaped rear tube 31 fixed to the base frame 10, arc-shaped tubes can not only reduce the number of tubes required but also increase the area of thrust force as compared to the straight tubes. Besides, the arc of the arc-shaped tubes avoids a connection point of an acute angle, thus preventing stress concentration while improving the structural strength of the chassis. Further, the arc-shaped front tube 21, the arc-shaped rear tube 31, the front connecting tube 22 and the rear connecting tube 32 are hollow, which contributes to light weight of the chassis.

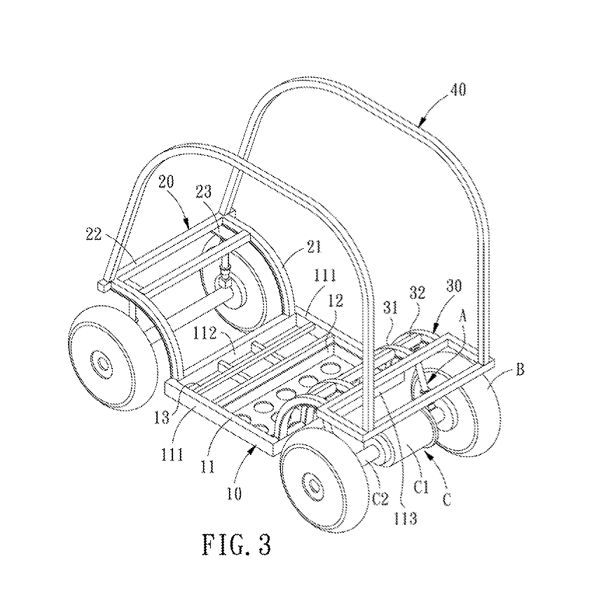

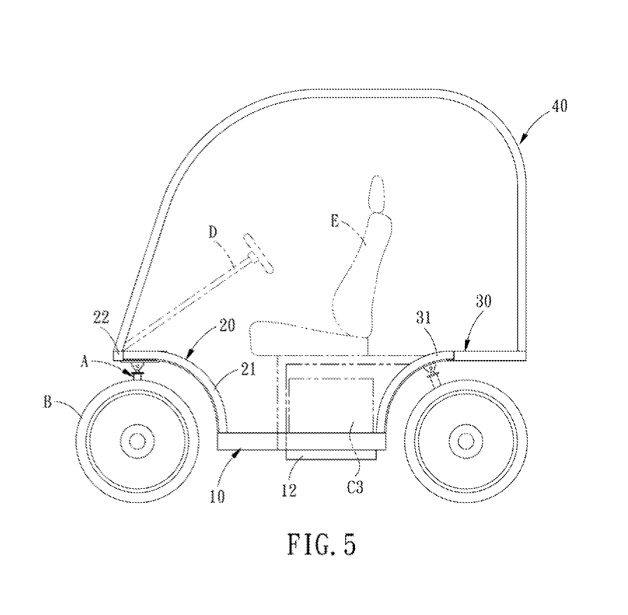

Referring then to FIGS. 3 and 5, the chassis in accordance with the present invention is provided for the assembly of an electric vehicle. Hence, on the chassis are to be mounted a drive C, a control device D and a seat E.

The drive C includes a motor C1, a drive shaft C2 and a plurality of batteries C3. The drive shaft C2 is driven by the motor C1 to rotate the two wheels B at the rear frame 30, and the motor C1 is electrically connected to the batteries C3.

The control device D is connected to the two wheels B at the front frame 20 to control the steering of the two wheels B at the front.

The seat E is mounted on the base frame 10.

While we have shown and described various embodiments in accordance with the present invention, it is clear to those skilled in the art that further embodiments may be made without departing from the scope of the present invention.

What is claimed is:

1. A chassis for an electric vehicle comprising:
a base frame being a rectangular structure formed by two side tubes, a front tube and a rear tube connected at both ends of the two side tubes;
a front frame including two arc-shaped front tubes with one end fixed to both ends of the front tube of the base frame, and a front connecting tube connected between another ends of the two arc-shaped front tubes, the front frame being further provided with two front mounting platforms connected to the two arc-shaped front tubes, respectively;
a rear frame including two arc-shaped rear tubes with one end fixed to both ends of the rear tube of the base frame, and a rear connecting tube connected between another ends of the two arc-shaped rear tubes; and
four suspension devices and four wheels, two of the four suspension devices each having one end fixed to the two front mounting platforms of the front frame and another end fixed to two of the four wheels, and another two of the four suspension devices each having one end fixed to both ends of the rear connecting tube and having another end fixed to another two of the four wheels.

2. The chassis for an electric vehicle as claimed in claim 1, wherein the base frame is further provided with a container for storing battery.

3. The chassis for an electric vehicle as claimed in claim 1, wherein the base frame is provided with a plurality of reinforced tubes for improving a load capacity of the base frame.

4. The chassis for an electric vehicle as claimed in claim 1, wherein the arc-shaped front tubes, the front connecting tube, the arc-shaped rear tubes and the rear connecting tube are hollow tubes.

5. The chassis for an electric vehicle as claimed in claim 1 further comprising two side frames each of which is an arc-shaped tube with both ends fixed to the front frame and the rear frame, respectively.
